(19) United States
(12) Patent Application Publication
(10) Pub. No.: US 2006/0163425 A1
(43) Pub. Date: Jul. 27, 2006

(54) Aircraft inlet assembly for reducing auxiliary power unit noise

(75) Inventors: Daniel V. Brown, Surprise, AZ (US); Yogendra Y. Sheoran, Scottsdale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/159,560

(22) Filed: Jun. 22, 2005

Related U.S. Application Data
(60) Provisional application No. 60/647,923, filed on Jan. 27, 2005.

(51) Int. Cl. B64D 33/02

(52) U.S. Cl. 244/53 B

(57) ABSTRACT

An aircraft inlet assembly is provided for damping noise from an auxiliary power unit (“APU”) of an aircraft having a tailcone including a sidewall with a first end and a second end, and an end wall coupled to the sidewall first end. The assembly includes a partition disposed within the tailcone and configured to divide the tailcone into a first compartment and a second compartment, the partition including an opening formed therein, an inlet opening formed in the tailcone sidewall in fluid communication with the first compartment, a first inlet duct extending between the inlet opening and the first compartment, an APU disposed within the second compartment, and a second inlet duct extending between the inlet opening and the partition opening to provide communication between the inlet opening and the second compartment.

### CROSS-REFERENCES TO RELATED APPLICATIONS

This application claims the benefit of U.S. Provisional Application No. 60/647,923, filed Jan. 27, 2005.

### TECHNICAL FIELD

The present invention relates to aircraft and, more particularly, to a system for decreasing noise propagated by an auxiliary power unit of an aircraft.

### BACKGROUND

Auxiliary power units (“APU”) are used in aircraft to provide electrical power and compressed air to various parts therein. When an aircraft is on the ground, its main source of electrical power comes from the APU. In particular, the APU can power the environmental control systems, air drive hydraulic pumps, and the starters for the engines. When an aircraft is in flight, the APU may provide pneumatic and/or electric power to the aircraft.

Typically, APUs are located in the aft section of the aircraft, at or near the tailcone section and include inlet and exhaust ducting that exit through an opening in the aircraft fuselage to allow sufficient air flow through to the APU. For aircraft on which APUs operate during flight, a ram air door is typically provided to protect the APU from foreign object damage when not in use and/or during ground movement, and to maximize total pressure supplied to the APU when performance at altitude is required.

However, while the ram air door is open, noise may propagate from the APU outward from the aircraft fuselage. The noise typically travels through the inlet duct and is deflected from the interior of the ram air door to sections or service locations of the aircraft that are forward the tailcone. Because many aircraft sections are located forward of the APU, such as, for example, passenger doors, passenger and aircraft personnel cabins, refueling points, and baggage doors, audible noise levels heard by those onboard the aircraft or those on the ground while handling baggage or performing aircraft maintenance may be increased.

Therefore, there is a need for an aircraft assembly that minimizes noise propagation from the APU when a ram air door is open. There is also a need for an aircraft assembly that delivers airflow to the APU with a minimum amount of pressure loss. There is also need for the aircraft assembly to be light weight and inexpensive to manufacture. The present invention addresses one or more of these needs.

### BRIEF SUMMARY

The present invention provides an aircraft inlet assembly for damping noise from an auxiliary power unit (“APU”) of an aircraft having a tailcone including a sidewall with a first end and a second end, and an end wall coupled to the sidewall first end. In one embodiment, and by way of example only, the assembly includes a partition disposed within the tailcone and configured to divide the tailcone into a first compartment and a second compartment, the partition including an opening formed therein, an inlet opening formed in the tailcone sidewall in fluid communication with the first compartment, a first inlet duct extending between the inlet opening and the first compartment, an APU disposed within the second compartment, and a second inlet duct extending between the inlet opening and the partition opening to provide communication between the inlet opening and the second compartment.

In another embodiment, and by way of example only, the assembly includes a partition dividing the tailcone into a first compartment and a second compartment, the partition comprising a first wall and a second wall, the first wall disposed between the APU and the tailcone sidewall and extending from the tailcone forward end aft, and the second wall extending from the first wall to the tailcone sidewall, an inlet opening formed in the tailcone sidewall in fluid communication with the first compartment, a first inlet duct extending between the inlet opening and the first compartment, and a second inlet duct extending between the inlet opening and the partition opening to provide communication between the inlet opening and the second compartment.

In still another embodiment, and by way of example only, the assembly includes an inlet opening formed in the tailcone sidewall, a partition disposed in the tailcone and configured to divide the tailcone into a first compartment and a second compartment, the partition having a first opening and a second opening formed therein, a first inlet duct extending between the inlet opening and the first compartment to provide communication therebetween, a second inlet duct extending between the inlet opening and the partition first opening to provide communication between the inlet opening and the second compartment, an APU disposed within the second compartment, and a side plenum defined in part by the tailcone sidewall to provide communication between the partition second opening and the APU.

Other independent features and advantages of the preferred aircraft inlet assembly will become apparent from the following detailed description, taken in conjunction with the accompanying drawings which illustrate, by way of example, the principles of the invention.

### BRIEF DESCRIPTION OF THE DRAWINGS

FIG. 1 is a side view of a schematic of an aircraft tailcone with a portion of its sidewall removed;

FIG. 2 is a side view of a schematic of another exemplary aircraft inlet assembly with a portion of its sidewall removed;

FIG. 3 is a top view of the exemplary aircraft inlet assembly shown in FIG. 2;

FIG. 4 is a side view of a schematic of still another exemplary aircraft inlet assembly with a portion of its sidewall removed;

FIG. 5 is a top view of the exemplary aircraft inlet assembly shown in FIG. 4;

FIG. 6 is a side view of a schematic of yet another exemplary aircraft inlet assembly with a portion of its sidewall removed;

FIG. 7 is a top view of the exemplary aircraft inlet assembly shown in FIG. 6;

FIG. 8 is a side view of a schematic of yet another exemplary aircraft inlet assembly with a portion of its sidewall removed; and

FIG. 9 is a top view of the exemplary aircraft inlet assembly shown in FIG. 8.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

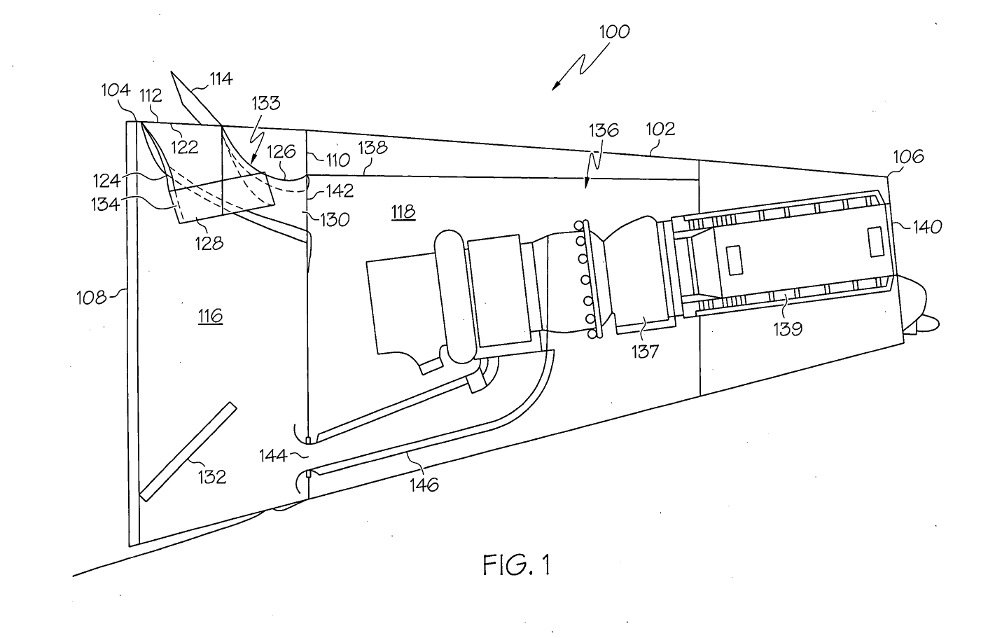

Turning now to the description, FIG. 1 shows a side view of a simplified aircraft tailcone 100 having an auxiliary power unit (“APU”) 136 disposed therein. The tailcone 100 includes a tubular sidewall 102, a forward end 104 and an aft end 106. The forward end 104 includes an end wall 108 coupled thereto. Disposed between the forward end 104 and the aft end 106 are an air inlet opening 112 and a partition 110. The air inlet opening 112 is formed in the tailcone sidewall 102 and although shown in FIG. 1 as being formed on a top portion of the sidewall 102 proximate the forward end 104, it will be appreciated that the air inlet opening 112 may be formed in any circumferential position around the tubular sidewall 102. To increase total pressure recovery to the APU 136 while in flight, a ram air door 114 is disposed over the inlet opening 112. The partition 110 is disposed inside the tailcone 100 to divide the tailcone 100 into a first and a second compartment 116, 118. Both compartments 116, 118 communicate with the air inlet opening 112 via a first inlet duct 124 and a second inlet duct 126, respectively. Preferably, the first and second inlet ducts 124, 126 have a side-by-side configuration such that the ram air door 114 services both ducts 124, 126.

The first inlet duct 124 is defined between an inlet 122 and a first outlet 128 and directs air to the first compartment 116. The second inlet duct 126 is defined between the inlet 122 and a second outlet 130, and extends through an opening 142 in the partition 110 to provide air to the second compartment 118.

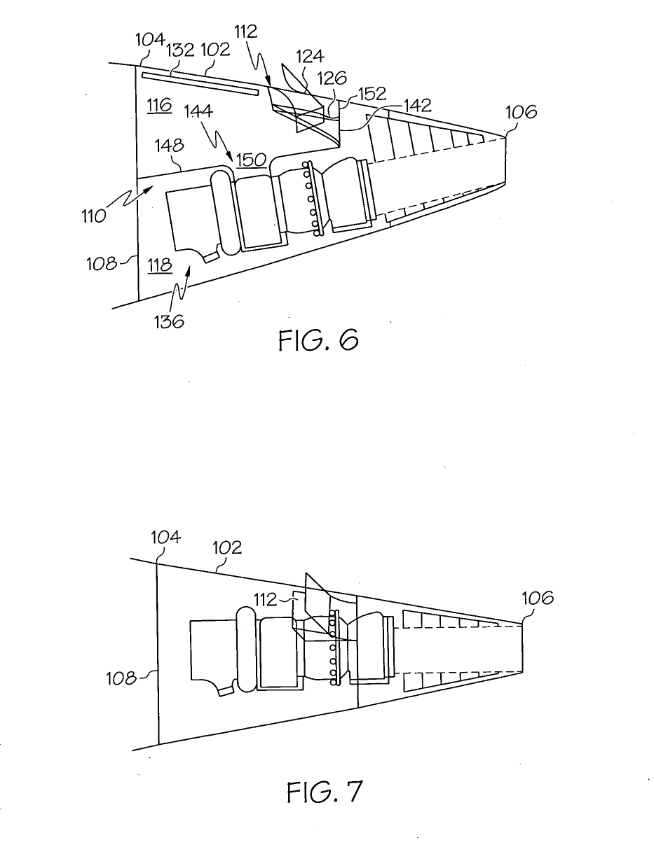

The first compartment 116 isolates and dampens noise that propagates from the APU 136. The noise may be dampened in several ways. In one exemplary embodiment, the first compartment 116 may have one or more sections of acoustically-treated material 132 disposed therein. The acoustically-treated material 132 may be any suitable material capable of damping noise, such as, for example, a porous facesheet bonded to a honeycomb material, a porous facesheet having baffles therein, or a bulk material with or without a facesheet. Additionally, the acoustically-treated material 132 may be disposed in any section of the first compartment 116. In one example, as shown in FIG. 1, the acoustically-treated material 132 is coupled to the end wall 108 towards the bottom of the tailcone 100 and oriented to reflect noise into the first compartment 116. In another example, the acoustically-treated material 132 is coupled to a top portion of the tailcone sidewall 102, as shown in FIGS. 6 and 8. In both cases, the acoustically-treated material 132 causes the APU 136 noise to propagate directly therein thereby maximizing attenuation.

Returning to FIG. 1, the first inlet duct 124 may be configured to cooperate with the first compartment 116 to further dampen noise. In this regard, the first inlet duct may include a dump diffuser 133. The dump diffuser 133 can also minimize aerodynamic losses. Preferably, the dump diffuser 133 has geometric characteristics that provide minimum aerodynamic loss while maintaining a relatively large change in cross-sectional area between the inlet 122 and the first outlet 128. This change in cross-sectional area slows air flow and reduces aerodynamic dump loss into first compartment 116. The first inlet duct 124 may be a straight walled diffuser, or a curved wall diffuser. A curved wall diffuser provides maximum flow velocity reduction while having a relatively short length. In one exemplary embodiment, a section of the first inlet duct 124 proximate the first outlet 128 has walls 134 that flare radially outward at a curvature measured from an axis that extends through the center of the duct 124 that is between about 7 degrees and about 24 degrees.

The second compartment 118 houses the APU 136 and is configured to receive air from the second inlet duct 126 to cool the second compartment 118 and provide air to an oil cooler 137 and eductor system 139 on the APU 136 for cooling oil within the APU 136. The exhaust opening 140 is formed in the sidewall 102 proximate the aft end 106 and communicates with the APU 136 to allow byproducts therefrom to exit the tailcone 100. Similar to the first inlet duct 124, the second inlet duct 126 may be defined as a curved wall dump diffuser to minimize inlet pressure losses.

It will be appreciated that the first compartment 116 and second compartment 118 may have any one of numerous configurations that depend upon the configuration of the partition 110. In one exemplary embodiment, as shown in FIG. 1, the partition 110 is a single wall 148 that extends radially inward from the tailcone sidewall 102 to substantially seal the first compartment 116 from the second compartment 118. The partition 110 includes a first opening 142, as briefly mentioned above, to which the second inlet duct 126 is sealingly coupled. The partition 110 may also serve as a firewall to isolate the second compartment 1118 from the first compartment 116.

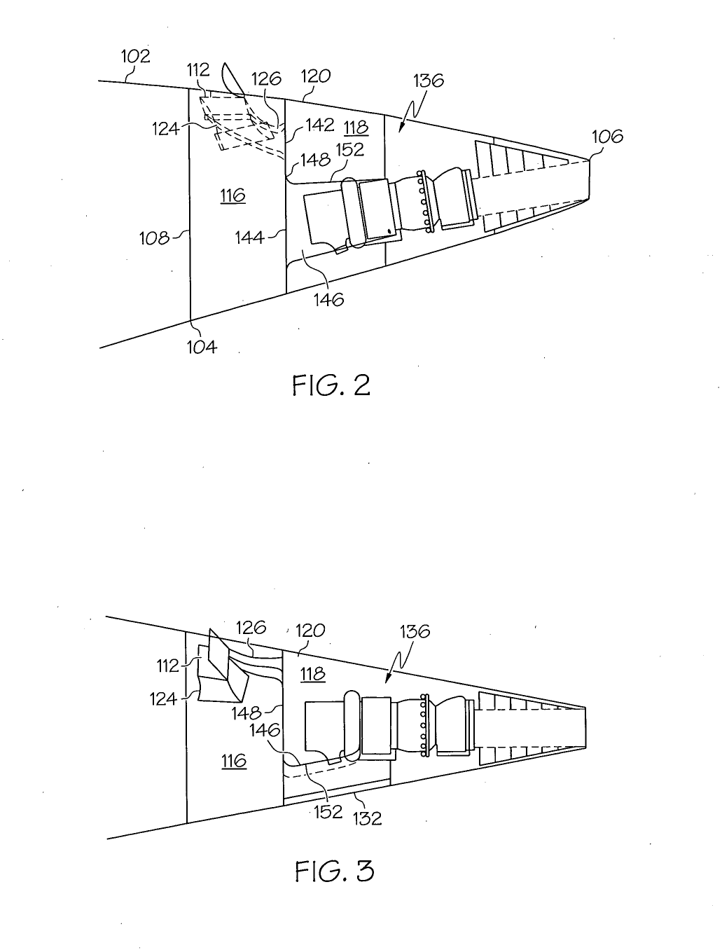

The partition 110 may also include a second opening 144 coupled to a side channel 146 that directs air from the first compartment 116 to the APU 136. The side channel 146 may be positioned along any portion of the aircraft, such as, for example along the side of the second compartment 118 as shown in FIGS. 2 and 3. Positioning the side channel 146 on the side of the aircraft allows maintenance personnel easier access to the APU 136. In a preferred embodiment, the cross-sectional area of the side channel 146 proximate the second opening 144 is smaller than the cross-sectional area of the side channel 146 in other sections thereof. In this regard, the acoustic benefit of the side channel 146 is maximized without increasing aerodynamic losses and flow-induced noise beyond acceptable levels. The side channel 146 may have one or more sections of acoustically treated material 132 disposed therein. It will be appreciated that although FIGS. 2 and 3 show the side channel 146 in a single position, it may be placed along any circumferential location around the APU 136

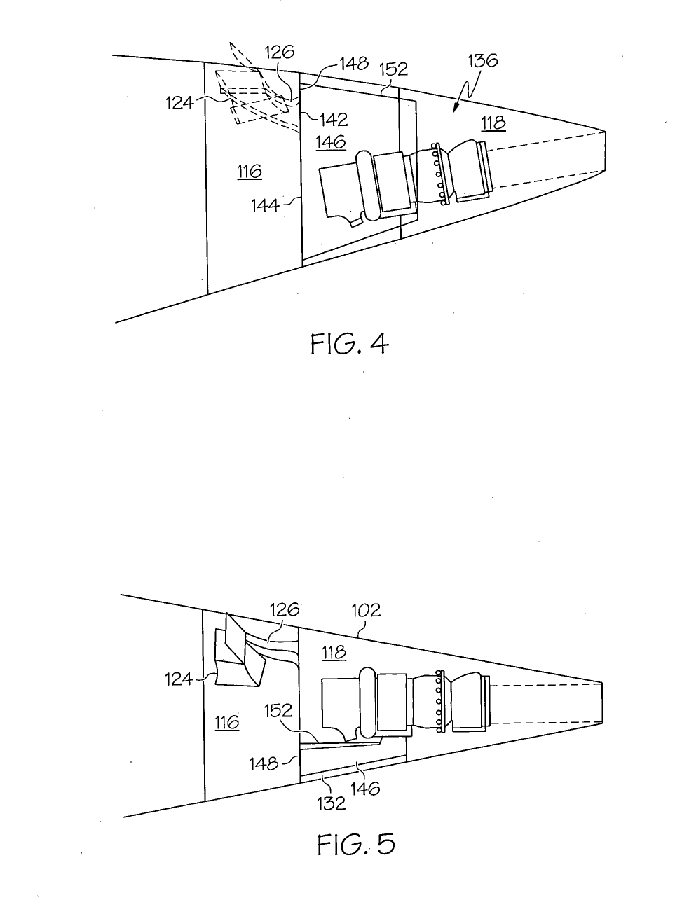

In another exemplary embodiment, as shown in FIGS. 4 and 5, the side channel 146 may be enlarged to define a plenum that communicates with the APU 136. In this case, the partition 110 comprises a plurality of walls. Specifically, the partition 110 includes a first wall 148 within which the second opening 144 is formed and a second wall 152 that extends from the first wall 148. While the plenum 146 is shown on the side of the APU 136, it will be appreciated that the second wall 152 may be oriented along any circumferential position around the APU 136. The plenum 146 may also include acoustically-treated material 132 to decrease noise that propagates therein. The acoustically-treated material 132 may be coupled to the sidewall 102 or any other section of the plenum 146.

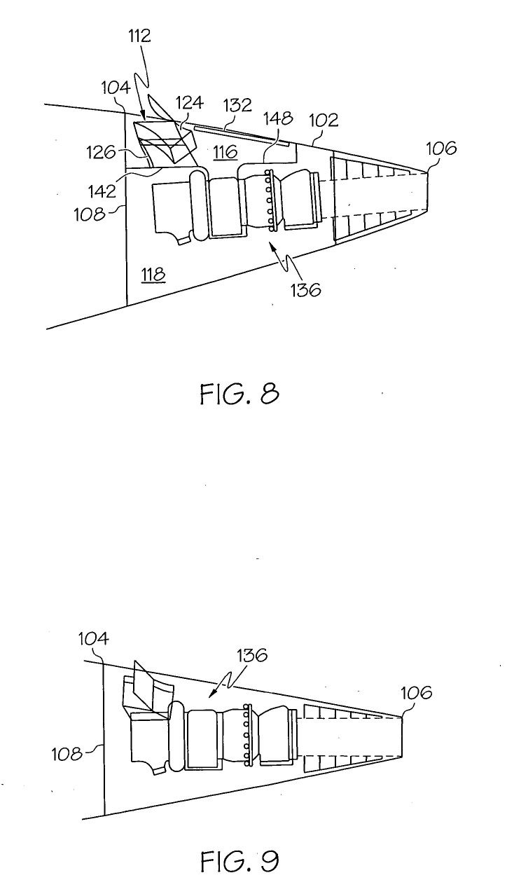

Turning now to FIGS. 6 and 7, still another exemplary embodiment is illustrated. In this embodiment, the partition 110, includes the first wall 148 and the second wall 152. However, the first wall 148 is disposed between the APU 136 and the tailcone sidewall 102 and extends aft from the end wall 108. The first wall 148 includes opening 144 formed therein that communicates directly with the APU 136 via a duct 150. The second wall 152 extends from the first wall 148 to the tailcone sidewall 102 and includes opening 142 through which the second inlet duct 126 communicates with the second compartment 118. Although the air inlet opening 112 is shown disposed substantially in the middle of the tailcone 100, it will be appreciated that the air inlet opening 112 may be formed in any other suitable section of the tailcone 100. For example, as shown in FIGS. 8 and 9, the air inlet opening 112 may be formed proximate the forward end 104 of the tailcone 100. In such case, the opening 142 through which the second inlet duct 126 communicates with the second compartment 118 may be formed in the first wall 148.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. An aircraft inlet assembly for damping noise from an auxiliary power unit (“APU”) of an aircraft having a tailcone including a sidewall with a first end and a second end, and an end wall coupled to the sidewall first end, the assembly comprising:
a partition disposed within the tailcone and configured to divide the tailcone into a first compartment and a second compartment, the partition including an opening formed therein;
an inlet opening formed in the tailcone sidewall in fluid communication with the first compartment;
a first inlet duct extending between the inlet opening and the first compartment;
an APU disposed within the second compartment; and
a second inlet duct extending between the inlet opening and the partition opening to provide communication between the inlet opening and the second compartment.

2. The assembly of claim 1, wherein the inlet opening is formed along a circumferential portion of the tailcone sidewall.

3. The assembly of claim 1, wherein the first inlet duct and the second inlet duct have a side-by-side configuration.

4. The assembly of claim 1, wherein the partition includes a second opening and the assembly further comprises:
a wall extending from the partition to the APU; and
a side plenum defined between the wall and the tailcone sidewall, wherein the side plenum is in communication with the second opening.

5. The assembly of claim 4, further comprising an acoustically-treated material disposed within the side plenum.

6. The assembly of claim 1, further comprising an acoustically-treated material disposed within the first compartment.

7. The assembly of claim 1, wherein the partition includes a second opening and the assembly further comprises a duct extending from the partition second opening to the APU.

8. The assembly of claim 1, wherein the partition includes a first wall that is disposed between the APU and the tailcone sidewall and extends from the tailcone forward end aft and a second wall extending from the first wall to the tailcone sidewall.

9. The assembly of claim 8, wherein the partition includes a second opening formed therein, the second opening in communication with the APU.

10. The assembly of claim 9, further comprising a duct disposed between the partition second opening and the APU.

11. The assembly of claim 1, wherein the first inlet duct has a dump diffuser with a curvature measured from an axis extending substantially through the center of the inlet duct at an angle of between about 7° and about 24°.

12. An aircraft inlet assembly for damping noise from an auxiliary power unit (“APU”) of an aircraft for use in a tailcone having a sidewall with a first end and a second end, and an end wall coupled to the sidewall first end, the assembly comprising:
a partition dividing the tailcone into a first compartment and a second compartment, the partition comprising a first wall and a second wall, the first wall disposed between the APU and the tailcone sidewall and extending from the tailcone forward end aft, and the second wall extending from the first wall to the tailcone sidewall;
an inlet opening formed in the tailcone sidewall in fluid communication with the first compartment;
a first inlet duct extending between the inlet opening and the first compartment; and
a second inlet duct extending between the inlet opening and the partition opening to provide communication between the inlet opening and the second compartment.

13. The assembly of claim 12, further comprising:
an acoustically-treated material disposed within the first compartment.

14. The assembly of claim 12, wherein the first inlet duct includes a dump diffuser with a curvature measured from an axis extending substantially through the center of the inlet duct at an angle of between about 7° and about 24°.

15. The assembly of claim 12, wherein the inlet opening is formed along a circumferential portion of the tailcone sidewall.

16. The assembly of claim 12, wherein the first inlet duct and the second inlet duct have a side-by-side configuration.

17. An aircraft inlet assembly for damping noise from an auxiliary power unit (“APU”) of an aircraft for use in a tailcone having a sidewall with a first end and a second end, and an end wall coupled to the sidewall first end, the assembly comprising:
an inlet opening formed in the tailcone sidewall;
a partition disposed in the tailcone and configured to divide the tailcone into a first compartment and a second compartment, the partition having a first opening and a second opening formed therein;
a first inlet duct extending between the inlet opening and the first compartment to provide communication therebetween;
a second inlet duct extending between the inlet opening and the partition first opening to provide communication between the inlet opening and the second compartment;
an APU disposed within the second compartment; and
a plenum defined in part by the tailcone sidewall to provide communication between the partition second opening and the APU.

18. The assembly of claim 17, wherein the plenum is defined by an interior duct that extends between the partition second opening and the APU.

19. The assembly of claim 17, further comprising an acoustically treated material disposed within the first compartment.

20. The assembly of claim 17, wherein the first inlet duct and the second inlet duct have a side-by-side configuration.
